(19) United States
(12) Patent Application Publication
(10) Pub. No.: US 2025/0353486 A1
(43) Pub. Date: Nov. 20, 2025

(54) HYBRID ELECTRIC VEHICLE AND METHOD FOR IGNITION CONTROL FOR SAME

(71) Applicants: HYUNDAI MOTOR COMPANY, Seoul (KR); KIA CORPORATION, Seoul (KR)

(72) Inventor: Key Chun Park, Hwaseong-si (KR)

(73) Assignees: HYUNDAI MOTOR COMPANY, Seoul (KR); KIA CORPORATION, Seoul (KR)

(21) Appl. No.: 18/931,279

(22) Filed: Oct. 30, 2024

(30) Foreign Application Priority Data
May 20, 2024 (KR) 10-2024-0065285

(51) Int. Cl. B60W 20/15; B60W 50/00

(52) U.S. Cl. CPC B60W 20/15; B60W 50/0097; B60W 2510/0657; B60W 2710/083

(57) ABSTRACT

The present disclosure relates to a hybrid electric vehicle and a method for ignition control for the same. The hybrid electric vehicle includes a power train including an engine, a motor, and a shaft to which the engine and the motor are connected together. The vehicle also includes a controller configured to predict, during the ignition, a torque change in the shaft by determining whether to apply a vibrational contribution due to combustion pressure torque according to whether initial explosion has occurred during ignition of the engine, and control torque of the motor during the ignition based on the predicted torque change, which can reduce vibration in an ignition process of the hybrid electric vehicle and enhance startability by predicting vibration and applying antiphase torque during ignition.

### CROSS-REFERENCE TO RELATED APPLICATION(S)

This application is based on and claims priority under 35 U.S.C. 119 to Korean Patent Application No. 10-2024-0065285, filed on May 20, 2024, in the Korean Intellectual Property Office, the disclosure of which is herein incorporated by reference in its entirety.

### TECHNICAL FIELD

The present disclosure relates to a hybrid electric vehicle capable of reducing vibration and enhancing startability during ignition, and a method for driving control for the same.

### BACKGROUND

Recently, as interest in the environment increases, use of eco-friendly vehicles having an electric motor as a power source is increasing. An eco-friendly vehicle is also referred to as an electrified vehicle, and a representative example thereof may include a hybrid electric vehicle (HEV) or an electric vehicle (EV).

A power train of the hybrid electric vehicle may include an ignition motor and an internal combustion engine connected to one shaft. The hybrid vehicle may increase, using the ignition motor connected to the engine, the number of rotations of the engine to a target rpm and remain the same, and may start the engine by combusting a fuel sprayed over an engine cylinder. In the engine ignition process, before reaching the target rpm, the number of rotations of the engine may be increased by controlling the motor to output applied torque greater than friction torque of the engine, and after reaching the target rpm, the target rpm (or idle rpm) may be maintained by causing the motor to output the same applied torque as the friction torque of the engine.

However, in the actual engine ignition process, in addition to the friction torque, pumping torque also causes a mechanical loss component of the engine. The pumping torque may cause a large variable torque in the engine ignition process, and the variable torque may not only cause vibration to the hybrid electric vehicle in the engine ignition process but also require an ignition motor capable of applying larger average torque.

### SUMMARY

The present disclosure is to provide a hybrid electric vehicle and a method for driving control for the same, which can reduce vibration caused by a change in mechanical loss torque of an engine in an engine ignition process and enhance startability by reducing average required torque required until ignition is completed.

The technical subjects pursued in the present disclosure may not be limited to the above-mentioned technical subjects, and other technical subjects which are not mentioned may be clearly understood, through the following descriptions, by those skilled in the art to which the present disclosure pertains.

To achieve the above-described objective, a method for controlling a hybrid electric vehicle according to an embodiment of the present disclosure may include varying whether to apply a vibrational contribution by combustion pressure torque according to whether an initial explosion has occurred during ignition of an engine, and predicting, during the ignition, a torque change in a shaft to which the engine and a motor are connected together, and controlling torque of the motor during the ignition based on the predicted torque change.

According to an embodiment of the present disclosure, the predicting of the torque change during the ignition may include, before the initial explosion, predicting the torque change in consideration of vibrational contributions of motoring pressure torque of the motor and inertial torque of the engine, and after the initial explosion, predicting the torque change in consideration of vibrational contributions of the motoring pressure torque, the inertial torque, and the combustion pressure torque.

According to an embodiment of the present disclosure, the controlling of the torque of the motor may include in a case where, before the initial explosion, motoring average torque causing occurrence of the motoring pressure torque corresponds to pre-configured maximum motoring torque, performing (e.g., providing) control to add, to the motoring average torque, correction torque obtained by inverting a positive (+) component of the predicted torque change.

According to an embodiment of the present disclosure, the controlling of the torque of the motor may include in a case where, before the initial explosion, motoring average torque causing occurrence of the motoring pressure torque is less than pre-configured maximum motoring torque, performing (e.g., providing) control to add, to the motoring average torque, correction torque obtained by inverting a negative (−) component of the predicted torque change.

According to an embodiment of the present disclosure, the controlling of the torque of the motor may include in a case after the initial explosion, performing (e.g., providing) control to add, to the motoring average torque, correction torque obtained by inverting all the predicted torque change.

According to an embodiment of the present disclosure, the inertial torque, the motoring pressure torque, and the combustion pressure torque may be determined based on a crank shaft angle position of the engine, the number of rotations of the shaft, and the motoring average torque.

According to an embodiment of the present disclosure, the crank shaft angle position of the engine may be determined by adding a pre-configured offset to a resolver position of the motor.

According to an embodiment of the present disclosure, the pre-configured offset may be configured to cause vibration to have a minimum level of amplitude during the ignition when torque obtained by summating the motoring average torque and an antiphase of the predicted torque change according to a position of the engine is applied to the motor.

According to an embodiment of the present disclosure, the level of amplitude of vibration during the ignition may be determined based on a square of a change in the number of rotations of the motor, and the inertial torque may be determined according to a pre-configured table based on the crank shaft angle position of the engine and the number of rotations of the shaft.

According to an embodiment of the present disclosure, the motoring pressure torque may be determined according to a pre-configured motoring pressure torque table based on the crank shaft angle position of the engine, the number of rotations of the engine, and the motoring average torque, and the combustion pressure torque may be determined according to a pre-configured combustion pressure torque table based on the crank shaft angle position of the engine, the number of rotations of the engine, and the motoring average torque.

A hybrid electric vehicle according to an embodiment of the present disclosure may include a power train including an engine, a motor, and a shaft to which the engine and the motor are connected together; and a controller configured to vary whether to apply a vibrational contribution by combustion pressure torque according to whether initial explosion has occurred during ignition of the engine, and predicting, during the ignition, a torque change in the shaft, and control torque of the motor during the ignition based on the predicted torque change.

According to an embodiment of the present disclosure, the controller may be configured to, before the initial explosion, predict the torque change in consideration of vibrational contributions of motoring pressure torque of the motor and inertial torque of the engine, and after the initial explosion, predict the torque change in consideration of vibrational contributions of the motoring pressure torque, the inertial torque, and the combustion pressure torque.

According to an embodiment of the present disclosure, the controller may be configured to, in a case where, before the initial explosion, motoring average torque causing occurrence of the motoring pressure torque corresponds to pre-configured maximum motoring torque, control the torque of the motor so as to add, to the motoring average torque, correction torque obtained by inverting a positive (+) component of the predicted torque change.

According to an embodiment of the present disclosure, the controller may be configured to, in a case where, before the initial explosion, motoring average torque causing occurrence of the motoring pressure torque is less than pre-configured maximum motoring torque, control the torque of the motor so as to add, to the motoring average torque, correction torque obtained by inverting a negative (−) component of the predicted torque change.

According to an embodiment of the present disclosure, the controller may be configured to, in a case after the initial explosion, control the torque of the motor so as to add, to the motoring average torque, correction torque obtained by inverting all the predicted torque change.

According to an embodiment of the present disclosure, the controller may be configured to determine the inertial torque, the motoring pressure torque, and the combustion pressure torque based on a crank shaft angle position of the engine, the number of rotations of the shaft, and the motoring average torque.

According to an embodiment of the present disclosure, the controller may be configured to determine the crank shaft angle position of the engine by adding a pre-configured offset to a resolver position of the motor.

According to an embodiment of the present disclosure, the pre-configured offset may be configured to cause vibration to have a minimum level of amplitude during the ignition when torque obtained by summating the motoring average torque and an antiphase of the predicted torque change according to a position of the engine is applied to the motor.

According to an embodiment of the present disclosure, the controller may be configured to determine the level of amplitude of vibration during the ignition based on a square of a change in the number of rotations of the motor, and determine the inertial torque according to a pre-configured table based on the crank shaft angle position of the engine and the number of rotations of the shaft.

According to an embodiment of the present disclosure, the controller may be configured to determine the motoring pressure torque according to a pre-configured motoring pressure torque table based on the crank shaft angle position of the engine, the number of rotations of the engine, and the motoring average torque, and determine the combustion pressure torque according to a pre-configured combustion pressure torque table based on the crank shaft angle position of the engine, the number of rotations of the engine, and the motoring average torque.

By the above-described various embodiments of the present disclosure, the present disclosure can reduce vibration in an ignition process of a hybrid electric vehicle and reduce a user's discomfort due to the vibration by predicting vibration and applying antiphase torque during ignition.

In addition, by the above-described embodiment of the present disclosure, an ignition time of a hybrid electric vehicle can be reduced and average torque required during ignition can be reduced.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an example of a configuration of a power train of a hybrid electric vehicle according to an embodiment of the present disclosure;

FIG. 2 illustrates an example of a control system configuration of a hybrid electric vehicle according to an embodiment of the present disclosure;

FIG. 3 illustrates a method for configuring a pre-configured offset for determining a crank angle position of an engine according to an embodiment of the present disclosure;

FIG. 4 illustrates a process of outputting correction torque by a hybrid controller according to an embodiment of the present disclosure;

FIG. 5 illustrates an implementation example of a hybrid controller including a prediction unit for predicting torque with reference to a table according to an embodiment of the present disclosure;

FIG. 6 is a flow chart illustrating an ignition operation of an engine by a hybrid controller according to an embodiment of the present disclosure;

FIG. 7A illustrates an effect of an embodiment of the present disclosure;

FIG. 7B is a comparative example comparing the effect of an embodiment of FIG. 7A to a case where time intervals from a start of ignition to complete explosion are the same;

FIG. 8A illustrates an effect of an embodiment of the present disclosure; and

FIG. 8B illustrates a comparative example comparing the effect of an embodiment of FIG. 8A to a case where the comparative example and the embodiment have the same average applied torque.

### DETAILED DESCRIPTION

Hereinafter, embodiments set forth herein will be described in detail with reference to the accompanying drawings, and the same or similar elements are given the same and similar reference numerals regardless of figure numbers, so duplicate descriptions thereof will be omitted. The terms “module” and “unit” used for the elements in the following description are given or interchangeably used in consideration of only the ease of writing the specification, and do not have distinct meanings or roles by themselves. Furthermore, in describing the embodiments disclosed in the present specification, when the detailed description of the relevant known technology is determined to unnecessarily obscure the gist of embodiments set forth herein, the detailed description thereof will be omitted. In addition, it should be appreciated that the accompanying drawings are provided only for the sake of understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression includes a plural expression unless they are definitely different in the context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A unit or a control unit included in names such as a motor control unit (MCU) and a hybrid control unit (HCU) is merely a term widely used for naming a controller configured to control a specific function of a vehicle, but does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to determine, calculate, decide or the like for responsible function controlling.

Before describing a method for ignition control for a hybrid electric vehicle according to various embodiments of the present disclosure, a structure and a control system of a hybrid electric vehicle applicable to the embodiments are described first.

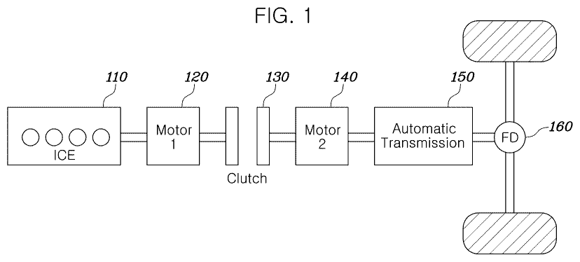

FIG. 1 illustrates an example of a configuration of a power train of a hybrid electric vehicle according to an embodiment of the present disclosure.

Referring to FIG. 1, illustrated is a power train of a hybrid electric vehicle employing a parallel-type hybrid system having two motors 120 and 140 and an engine clutch 130 mounted between an engine (internal combustion engine (ICE) 110 and a transmission 150. Such a parallel-type hybrid system is also referred to as a transmission mounted electric drive (TMED) hybrid system since the motor 140 is always connected to an input terminal of the transmission 150.

Here, the first motor 120 of the two motors 120 and 140 is disposed between the engine 110 and one end of the engine clutch 130, and a crank shaft of the engine 110 and a first motor shaft of the first motor 120 are directly connected to each other and are always thus rotatable together. Accordingly, a crank shaft angle position change and rotation number of the engine 110 may be identical to a first motor shaft angle position change and rotation number of the motor 120, respectively.

One end of a second motor shaft of the second motor 140 may be connected to the other end of the engine clutch 130, and the other end of the second motor shaft may be connected to an input terminal of the transmission 150.

The second motor 140 has a larger output than the first motor 120, and the second motor 140 may take a role of a driving motor. In addition, the first motor 120 may perform a function of an ignition motor for cranking the engine 110 during ignition of the engine 110, may recover rotation energy of the engine 110 through power generation when the engine is off, and may also perform power generation by powering of the engine 110 while the engine 110 is on.

In the hybrid electric vehicle including the power train as illustrated in FIG. 1, when a driver steps on an accelerator pedal after ignition (e.g., HEV ready), the second motor 140 is driven first by using power of a battery (not shown) while the engine clutch 130 is opened. Accordingly, the power of the second motor 140 is transmitted through the transmission 150 and a final drive (FD) 160 and wheels are moved (e.g., EV mode). When a much larger driving force is required as the vehicle is gradually accelerated, the first motor 120 is operated so as to crank the engine 110.

After the ignition of the engine 110, when a rotation speed difference between the engine 110 and the second motor 140 falls within a predetermined range, the engine clutch 130 is finally engaged and the engine 110 and the second motor 140 are rotated together (e.g., transition from EV mode to HEV mode). Accordingly, through a torque blending process, the output of the second motor 140 is reduced, and the output of the engine 110 is increased, whereby torque required by the driver can be satisfied. In the HEV mode, most of the required torque can be satisfied by the engine 110, and a difference between engine torque and the required torque may be compensated by at least one of the first motor 120 and the second motor 140. For example, when the engine 110 outputs torque greater than the required torque in consideration of the efficiency of the engine 110, the first motor 120 or the second motor 140 generates as much power as a surplus of the engine torque, and when the engine torque is less than the required torque, at least one of the first motor 120 and the second motor 140 outputs deficiency torque.

When a pre-configured engine-condition, such as a case where the vehicle is deaccelerated is satisfied, the engine clutch 130 is opened and the engine 110 stops (i.e., transition from HEV mode to EV mode). During the deceleration, the battery is charged through the second motor 140 by using driving forces of wheels, and this is called braking energy regeneration, or generative braking.

In general, for the transmission 150, a step-variable transmission or a multi-plate clutch (e.g., a dual clutch transmission (DCT)) may be used.

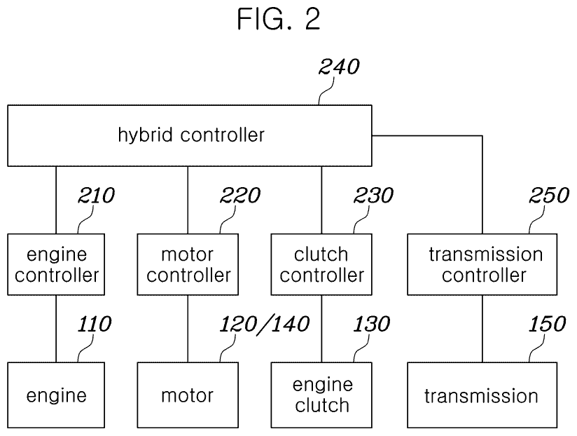

FIG. 2 illustrates an example of a control system configuration of a hybrid electric vehicle according to an embodiment of the present disclosure.

Referring to FIG. 2, in a hybrid electric vehicle to which embodiments of the present disclosure are applicable, the internal combustion engine 110 may be controlled by an engine controller 210, torque of the first motor 120 and the second motor 140 may be controlled by a motor controller (MCU) 220, and the engine clutch 130 may be controlled by a clutch controller 230. Here, the engine controller 210 also may be referred to as an engine management system (EMS). In addition, the transmission 150 is controlled by a transmission controller 250.

The motor controller 220 may control a gate drive unit (not shown) by a control signal in the form of pulse width modulation (PWM) based on a motor angle, a phase voltage, a phase current, required torque, and the like acquired from a motor resolver, a voltage sensor, a current sensor, and the like attached to each of the motors 120 and 140, and the gate drive unit may accordingly control an inverter (not shown) for driving each of the motors 120 and 140.

Each controller may be connected to a hybrid controller (hybrid controller unit (HCU)) 240, which is a higher (e.g., overall) controller of each controller and controls the overall process of the power train including a mode transition process, and may provide the HCU 240 with information for engine clutch control and/or information for engine stop control during driving move changing or gear shifting according to control by the HCU 240, or may perform an operation according to a control signal.

For example, the HCU 240 determines whether to perform a transition between EV and HEV modes or CD and CS modes (in a case of PHEV) according to a driving state of the vehicle. To this end, the HCU 240 determines an open time (e.g., time point) of the engine clutch 130 and performs hydraulic control during the opening.

In addition, the HCU 240 may determine a state (e.g., lock-up, slip, open, and the like) of the engine clutch 130 and may control a fuel injection stop time (e.g., time point) of the engine 110.

In addition, the HCU 240 may transfer, to the motor controller 220, a torque command for controlling torque of the first motor 120 for stop control of the engine 110, so as to control engine rotation energy recovery. Moreover, the HCU 240 may determine the state of each driving source (e.g., the engine 110, the first motor 120, or the second motor 140) to satisfy the required torque, determine a required driving force shared by each driving source (e.g., the engine 110, the first motor 120, or the second motor 140) accordingly, and transfer a torque command to the engine controller 210 or the motor controller 220 for controlling each driving source.

The above-described connection relationship between the controllers and function/division of each of the controllers are merely provided as an example, and thus it is obvious to those skilled in the art that the names thereof are not limited. For example, the HCU 240 may be implemented so that the function thereof is replaced by one of the other controllers except for the HCU, and the corresponding function may be distributed to two or more of the other controllers.

The above-described configurations of FIG. 1 and FIG. 2 are merely provided as an example of a configuration of a hybrid electric vehicle, and it will be obvious to those skilled in the art that a hybrid electric vehicle applicable to the embodiments is not limited to such a structure.

Before describing a detailed hybrid electric vehicle control method to which the present disclosure is applied, for convenience of description, types of torque used to control a hybrid electric vehicle are defined as follows.

“Motoring average torque” may mean predetermined torque pre-configured so that the first motor 120 can perform cranking and increase engine rpm until the engine 110 reaches a target rpm or higher. Motoring average torque may be used to have a similar meaning to “required ignition torque” of the engine 110.

In an ignition process, before reaching target rpm, rpm of the engine 110 is increased when the motoring average torque corresponding to applied torque of a motor is greater than a mechanical loss torque of the engine, and thus it is desirable that the motoring average torque of the first motor 120 is greater than the mechanical loss torque of the engine 110.

“Variable torque” is variable torque generated due to friction in the engine 110 and variance in pumping during a rotation process of the engine 110, and may include inertial torque and pressure torque.

The inertial torque is torque generated at a crank shaft as a reciprocating mass including a piston of the engine 110 is rotated, and may be proportional to the square of the number of rotations per minute (rpm) of the engine 110.

The pressure torque may be divided into motoring average torque and combustion pressure torque. The motoring average torque may mean a torque change in a crank shaft of the engine 110, which is generated in a dynamometer (Dyno) of the engine 110, only through entrance and exit of air without fuel combustion. The combustion pressure torque may mean torque generated by a pressure component only by combustion after excluding the motoring pressure from the pressure generated during the fuel combustion in the dynamometer of the engine 110.

In this case, the variable torque may be determined by varying a vibrational contribution of the combustion pressure torque among the pressure torque according to whether initial explosion in a cylinder of the engine 110 occurs.

In a case before the initial explosion, torque by the combustion in the cylinder of the engine 110 does not need to be considered, and thus the variable torque may be determined based on vibrational contributions of the inertial torque and the motoring pressure torque.

In a case after the initial explosion, torque by the combustion in the cylinder of the engine 110 also needs to be considered, and thus the variable torque may be determined in consideration of all the vibrational contributions of the inertial torque, the motoring pressure torque, and the combustion pressure torque.

“Correction torque” may mean torque applied, in addition to the motoring average torque, through the first motor 120 by the HCU 240 in order to reduce the vibration due to the variable torque during ignition and reduce the required torque. For example, the HCU 240 may determine, as correction torque, torque obtained by inverting the phase of the variable torque, and perform (e.g., provide) control so that torque corresponding to torque obtained by summating the correction torque and the motoring average torque is output from the first motor 120.

Unless specially limited, “applied torque” may mean a total sum of torque output by the first motor 120 in the process of controlling the first motor 120 by the HCU 240. For example, in an ignition process of a hybrid electric vehicle, the applied torque of the first motor 120 may correspond to a sum of the motoring average torque and the correction torque. Specifically, the applied torque in a process of cranking the engine by the first motor 120 may be also referred to as “ignition torque”.

As described above in the description of FIG. 1, the engine shaft of the engine 110 and the shaft of the first motor 120 are directly connected to each other and are always rotated together, and thus information of the engine 110 may be identified based on information of the first motor 120.

For example, when an angle position of the shaft of the first motor 120 may be identified in the rotation process, an angle position of the crank shaft of the engine 110 may be also identified as a value obtained by adding a pre-configured offset to the angle position of the shaft of the first motor 120.

In this case, the crank shaft of the engine 110 and the shaft of the first motor 120 are assembled at predetermined positions during initial assembly, and thus an offset may vary for each assembled hybrid electric vehicle.

Hereinafter, for convenience of description, the angle position of the crank shaft of the engine 110 may be used to have the same meaning as the position of the engine 110. Similarly, the angle position of the crank shaft of the first motor 120 may be used to have the same meaning as the position of the first motor 120.

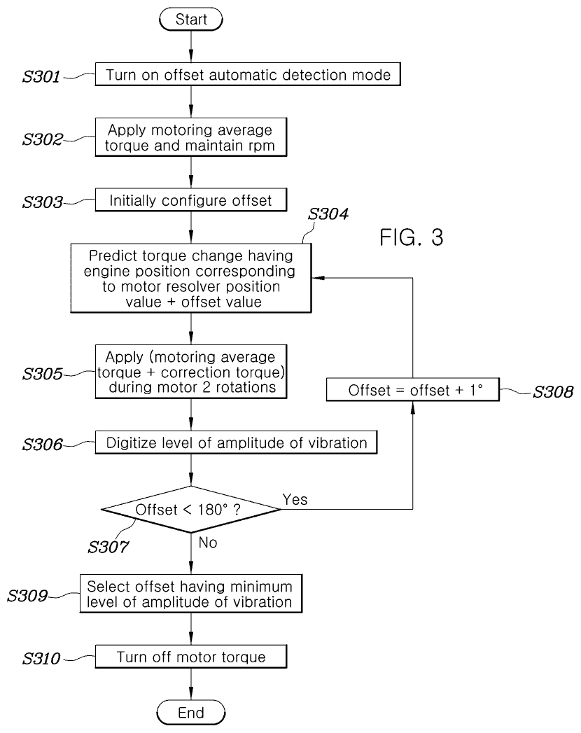

FIG. 3 illustrates a method for configuring an offset for determining the position of an engine 110 according to an embodiment of the present disclosure.

Upon entering into an automatic offset detection mode, after mounting the engine 110 in a vehicle (operation S301), the HCU 240 may control the first motor 120 to output motoring average torque and maintain pre-configured specific rpm (operation S302). Accordingly, the engine 110 directly connected to the first motor 120 generates a change in motoring torque while rotating at the same rpm.

When the first motor-engine shaft maintains the specific rpm, the HCU 240 may determine an initial configuration so that an offset corresponding to a difference between the shaft of the first motor 120 and the shaft of the engine 110 is configured to be 0 (operation S303).

The HCU 240 may configure, as a temporary position of the engine 110, a position obtained by adding the configured offset to the position of the first motor 120, and predict a torque change at the configured temporary position (operation S304).

For example, the HCU 240 may determine, as a potential position of the engine 110, a position by adding offset 0 to the position of the shaft of the first motor 120, based on the offset configured as 0, wherein the position of the shaft of the first motor is obtained from a resolver signal of the first motor 120. Configuring a potential position of the engine 110 may mean predicting a crank shaft angle position of the engine 110, and a motoring torque change generated in the engine may be predicted with reference to such a crank shaft angle position.

In addition, the first motor controller 220 may provide control to add correction torque to the motoring average torque and apply the same to the first motor 120 while the first motor 120 performs 2 rotations (operation S305).

While the first motor 120 performs 2 rotations, the crank shaft of the engine 110, which is directly connected thereto also performs 2 rotations, and thus the HCU 240 may apply the motoring average torque and the correction torque to the engine 110 for 1 cycle of the engine 110 based on the variable torque corresponding to the temporary position of the engine 110.

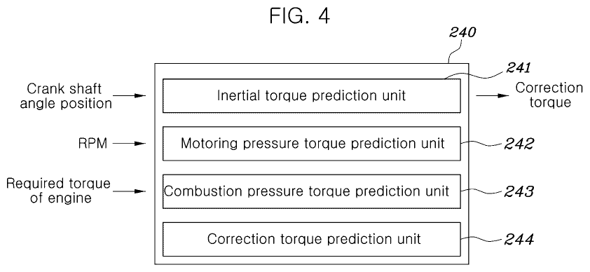

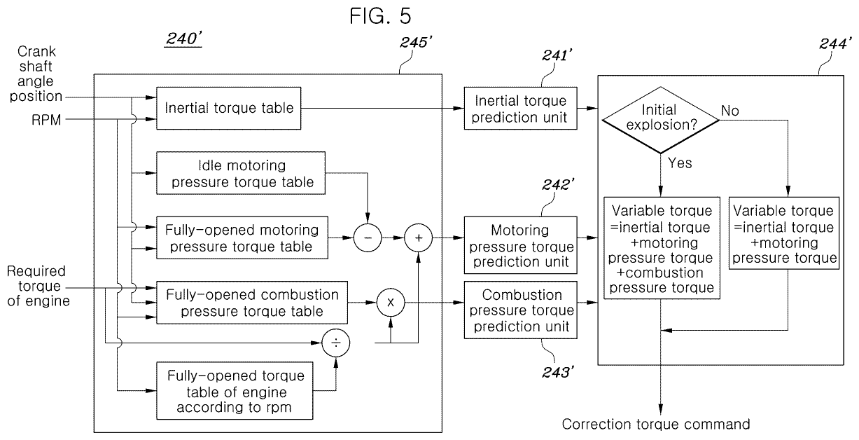

In this case, the correction torque may be determined based on the temporary position and rpm of the engine 110 and the required torque of the engine 110 according to a method to be described below with reference to FIG. 4 and FIG. 5.

While the motoring average torque and the correction torque are applied to the first motor 220, the HCU 240 may digitize the level of amplitude of tachometer vibration (operation S306).

For example, the first motor controller 220 may differentiate the position of a resolver in the first motor 120 to obtain a rotation speed of the first motor 120, and a value of the rotation speed of the resolver may be transmitted from the first motor controller 220 to the HCU 240 via CAN communication, and the like. Accordingly, the HCU 240 may calculate a real-time torque change according to the rotation speed based on the transmitted data.

In this case, the HCU 240 may obtain the square of the determined variable torque and then digitize the level of amplitude of vibration by accumulating sample signals within a specific cycle.

For example, in a case of a 4-stroke engine, when 2 rotations of the crank shaft of the engine 110 is considered as 1 cycle, ¼ cycle corresponding to each stroke may be configured as a specific cycle. Accordingly, the HCU 240 may digitize the level of amplitude of vibration by accumulating sample signals within the specific cycle based on the temporary position of the engine 110.

However, the above-described method for digitizing the level of amplitude of vibration is merely provided as an example, and the level of amplitude of vibration may be more precisely digitized in a method of Fourier-converting measurement data and comparing sizes of frequency components, and the like.

In addition, the HCU 240 may compare whether the size of a currently configured offset is less than 180 degrees (operation S307).

If the size of the offset is less than 180 degrees (if “Yes” in operation S307), the HCU 240 may configure the offset as a value obtained by adding 1 degree to the previous offset and repeat the above-described operations S304 to S307 (operation S308).

However, 1 degree is merely provided as an example, and it is obvious to those skilled in the art that 1 degree may be replaced by another value configured in consideration of the precision of offset configuration and the speed of the offset configuration.

If the size of the offset is greater than 180 degrees (if “No” in operation S307), an offset having the minimum level of amplitude of vibration corresponding to all measured offsets may be configured as a final offset (operation S309).

Specifically, the HCU 240 may match the position of the engine 110 at which the variable torque is generated and the temporary position of the engine 110 to which correction torque obtained by inverting the variable torque is applied, so as to configure, as a final offset, the offset having the minimum level of the amplitude of tachometer vibration.

When the offset configuration is completed, the first motor controller 220 may turn off the applied torque of the first motor 120 (operation S310).

The above-described offset configuration control may be performed (e.g., one time) during initial ignition after assembly of a hybrid electric vehicle.

For example, this process may be performed (e.g., during initial ignition) in a final inspection process before releasing and after completion of a vehicle, or may be performed during initial ignition after vehicle delivery, and the above-described offset configuration may be also performed additionally when there is inspection or replacement of the engine 110 or the first motor 120.

FIG. 4 illustrates a process of outputting correction torque by an HCU 240 according to an embodiment of the present disclosure.

The HCU 240 may use information related to the engine 110 to predict correction torque. In this case, the information related to the engine 110 may include a crank shaft angle position of the engine 110 (or the position of the engine 110), the number of rotations (or rpm), required torque (or motoring average torque) of the engine 110, and the like.

Referring to FIG. 4, the HCU 240 may include an inertial torque prediction unit 241, a motoring pressure torque prediction unit 242, a combustion pressure torque prediction unit 243, and a correct torque prediction unit 244. Hereinafter, a function of each prediction unit is described in detail.

First, the inertial torque prediction unit 241 may predict inertial torque (or an inertial torque component) based on a crank shaft angle position and the number of rotations of the engine 110.

Here, the inertial torque prediction unit 241 may determine the crank shaft angle position of the engine 110 as a position obtained by adding a pre-configured offset to the position of the first motor 120 according to the process described in FIG. 3.

Similarly, the inertial torque prediction unit 241 may determine the rpm of the engine 110 as the same value as the rpm obtained from a resolver of the first motor 120.

In this case, the inertial torque prediction unit 241 may predict inertial torque by multiplying an inertial torque table output value corresponding to the crank shaft angle position of the engine 110 and the square of rpm of the engine 110, acquired by the HCU 240.

Here, the inertial torque table may be written to correspond to the inertial torque according to the crank shaft angle position of the engine 110 through repeated experiments. In this case, in order to minimize storage in the HCU 240, the inertial torque table may be stored by dividing variable torque according to the crank shaft angle position by the square of the rpm.

In addition, the motoring pressure torque prediction unit 242 may predict pressure torque based on the crank shaft angle position of the engine 110, the number of rotations, and the required torque of the engine 110.

The motoring pressure torque may be divided into a motoring pressure torque component taking into consideration the degree of opening of a throttle valve, and a motoring pressure torque component in a state in which the throttle value is closed.

The motoring pressure torque component taking into consideration the degree of opening of the throttle valve may be predicted based on the crank shaft angle position of the engine 110, the rpm, and the required torque of the engine 110.

For example, the motoring pressure torque prediction unit 242 may predict fully-opened motoring pressure torque from a fully-opened motoring pressure torque table according to the crank shaft angle position.

Here, the fully-opened motoring pressure torque table has the number of rotations of the engine 110 as a fixed parameter, and may be written in advance to correspond to the torque according to the angle position of the crank shaft through repeated experiments while the throttle value of the engine 110 is fully opened.

In this case, the motoring pressure torque prediction unit 242 may predict the motoring pressure torque component considering the degree of opening of the throttle value by multiplying the fully-opened motoring pressure torque and a pre-configured weight taking into consideration the rpm and the required torque of the engine 110.

The motoring pressure torque component while the throttle value is closed may be predicted based on an idle motoring pressure torque table corresponding to the crank shaft angle position of the engine 110.

Here, the idle motoring pressure torque table has the number of rotations of the engine 110 as a fixed parameter, and may be written based on data obtained through repeated experiments on the idle motoring torque according to the crank shaft angle position.

Accordingly, the motoring pressure torque prediction unit 242 may predict, based on the above-described method, the motoring pressure torque component considering the degree of opening of the throttle value and the motoring pressure torque component in the state in which the throttle value is closed, and may predict the motoring pressure torque by adding the two torque components.

The combustion pressure torque prediction unit 243 may predict combustion pressure torque based on the crank shaft angle position of the engine 110, the rpm, and the required torque of the engine 110.

The combustion pressure torque prediction unit 243 may predict fully-opened combustion pressure torque from a fully-opened combustion torque table according to the crank shaft angle position, and may predict the combustion pressure torque by multiplying the fully-opened combustion pressure torque and a pre-configured weight in consideration of the rpm and the required torque of the engine 110.

Here, the fully-opened combustion pressure torque table may be written through repeated experiments based on a torque change according to the angle position of the crank shaft in the state in which the throttle value of the engine 110 is fully opened.

Here, the fully-opened combustion pressure torque table may be written as a two-dimensional fully-opened combustion pressure torque table with additional consideration of a torque change according to the rpm of the engine 110.

In addition, the weight pre-configured in consideration of the rpm and the required torque of the engine 110 may be configured as a fully-opened torque table of the engine 110 according to the rpm.

Here, the fully-opened torque table of the engine 110 according to the rpm may be written through repeated experiments on the weight of the combustion pressure torque according to the rpm and the required torque of the engine 110.

However, in a case before the initial explosion, the vibrational contribution due to the combustion in the cylinder of the engine 110 does not need to be considered during the prediction of correction torque, and thus a process of predicting the combustion pressure torque by the combustion pressure torque prediction unit 243 before the initial explosion may be omitted.

The correction torque prediction unit 244 predicts variable torque and calculate correction torque based on the predicted inertial torque and pressure torque and the required torque of the engine 110.

The correction torque prediction unit 244 may predict the variable torque by deducting the required torque of the engine 110 from a value obtained by summating the inertial torque and the pressure torque.

Here, the variable torque may be determined by varying the vibrational contribution of the combustion pressure torque among the pressure torque according to whether the initial explosion occurs in the cylinder of the engine 110.

For example, the variable torque before the initial explosion of the engine 110 may be determined as torque obtained by deducting the motoring average torque from torque obtained by summating the inertial torque and the motoring pressure torque.

For example, the variable torque after the initial explosion of the engine 110 may be determined as torque obtained by deducting the motoring average torque from torque obtained by summating the inertial torque, the motoring pressure torque, and the combustion pressure torque.

In addition, the correction torque prediction unit 244 may predict correction torque for offsetting variable torque of the engine 110 based on the predicted variable torque.

For example, it may be predicted that the correction torque has a phase that is opposite to that of the predicted variable torque, and has the same size as the predicted variable torque.

FIG. 5 illustrates an example of an HCU including a prediction unit for predicting torque with reference to a table according to an embodiment of the present disclosure.

Referring to FIG. 5, illustrated is a corresponding relationship between respective prediction units 241′ to 244′ (e.g., 241′, 242′, 243′, 244′) of an HCU 240′ and multiple tables stored in a table operation unit 245′.

The corresponding relationship of the table used by each prediction unit is similar to that described in FIG. 4, and a redundant description is omitted.

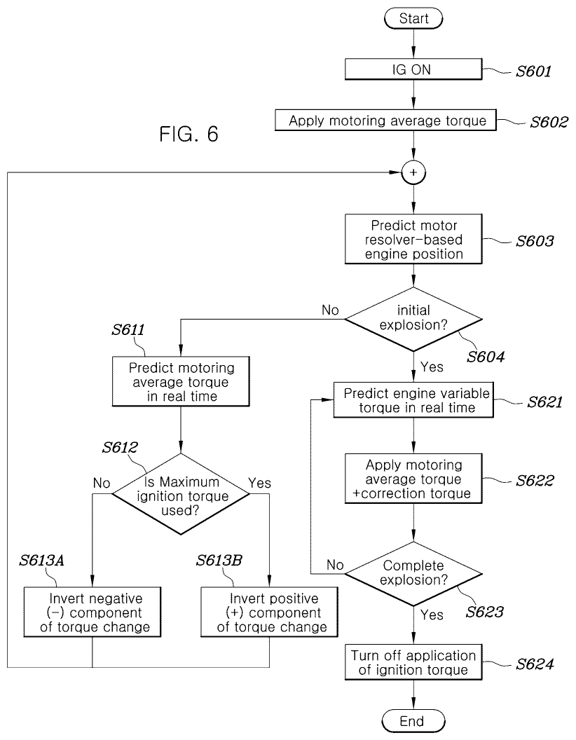

FIG. 6 is a flow chart illustrating an ignition operation of an engine 110 by an HCU 240 according to an embodiment of the present disclosure.

When there is an ignition ON command of the engine 110 (operation S601), the HCU 240 may control the first motor 120 to apply motoring average torque (operation S602).

For example, the HCU 240 may transfer a torque command to the first motor controller 220 to cause the first motor 120 to output the motoring average torque, and the first motor controller 220 may control the first motor 120 to output the motoring average torque. In this case, when the first motor 120 outputs the motoring average torque, the engine 110 directly connected to the shaft of the first motor 120 also may be rotated together.

In this case, the HCU 240 may predict the position of the engine 110 based on the position of a resolver of the first motor 120 (operation S603).

For example, the HCU 240 may identify the position of the first motor 120 based on an angle signal of the resolver of the motor, and determine the position of the engine 110 by adding a pre-configured offset.

In addition, the HCU 240 may determine whether an initial explosion of the engine 110 has been occurred (operation S604).

For example, whether the initial explosion has been occurred may be determined according to whether there has been control of an ignition plug by the engine controller 210 or the rpm of the engine 110. A detailed method for determining whether the initial explosion has occurred is similar to that in the conventional art and is thus omitted.

If it is determined that the initial explosion has not occurred (if “No” in operation S604), the HCU 240 may predict, in real time, variable motoring torque based on vibrational contributions of inertial torque and motoring pressure torque before the initial explosion (operation S611).

Similar to the description made in FIGS. 4 and 5, the HCU 240 may predict the inertial torque and the motoring pressure torque based on the position of the engine 110, rpm, and required torque of the engine 110, and may predict variable torque by summating the inertial torque and the motoring pressure torque.

In this case, if the motoring average torque of the first motor 120 does not use pre-configured maximum motoring torque before the initial explosion (if “No” in operation S612), the HCU 240 may control correction torque obtained by inverting a negative (−) component among the predicted variable torque to be output (operation S613A).

The HCU 240 may reduce the required torque of the engine 110 in the process of ignition by appropriately outputting a positive (+) component of correction torque at a required (e.g., specific) time (e.g., time point) according to the negative (−) component of the variable torque of the engine 110.

However, in this case, in consideration of the level of amplitude of vibration and an ignition time of the engine 110, correction torque obtained by inverting all components including not only the negative (−) component but also the positive (+) component may be output, as necessary.

In addition, if the motoring average torque of the first motor 120 is using the maximum motoring torque before the initial explosion (if “Yes” in operation S612), the HCU 240 may control correction torque obtained by inverting the positive (+) component of the predicted variable torque to be output (operation S613B).

The HCU 240 may reduce the vibration of the engine 110 in the process of ignition by appropriately outputting the negative (−) component of correction torque at a required (e.g., specific) time (e.g., time point) according to the positive (+) component of the variable torque of the engine 110.

In this case, the above-described operations S611, S612, S613A, and S613B may be repeatedly performed until the initial explosion occurs.

If the initial explosion has occurred (if “Yes” in operation S604), the HCU 240 may predict, in real time, variable torque of the engine 110 based on vibrational contributions of inertial torque, motoring pressure torque, and combustion pressure torque (operation S621).

Similar to the description made in FIGS. 4 and 5, the HCU 240 may predict the inertial torque, the motoring pressure torque, and the combustion pressure torque based on the position of the engine 110, the rpm, and the required torque of the engine 110, and may predict variable torque by summating the inertial torque, the motoring pressure torque, and the combustion pressure torque.

In this case, the HCU 240 may perform (e.g., provide) control so that applied torque obtained by adding, to the motoring average torque, correction torque obtained by inverting the variable torque is output through the first motor 120 (operation S622).

The HCU 240 may determine whether complete explosion has occurred (operation S623), and if the complete explosion has not occurred (if “No” in operation S623), may repeat the above-described operations S621 and S622 until the complete explosion occurs.

If the complete explosion has occurred (if “Yes” in operation S623), the HCU 240 may turn off the torque output of the first motor 120 (operation S624).

Here, the HCU 240 may determine whether the complete explosion has occurred based on whether rpm has reached the target rpm, and whether the complete explosion has occurred may be determined similar to the initial explosion determination described in operation S604 above.

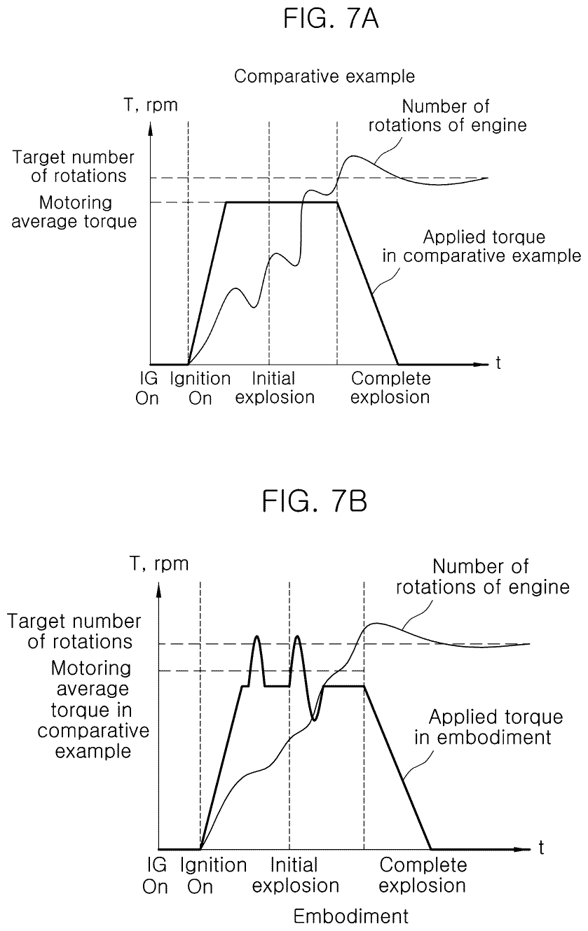

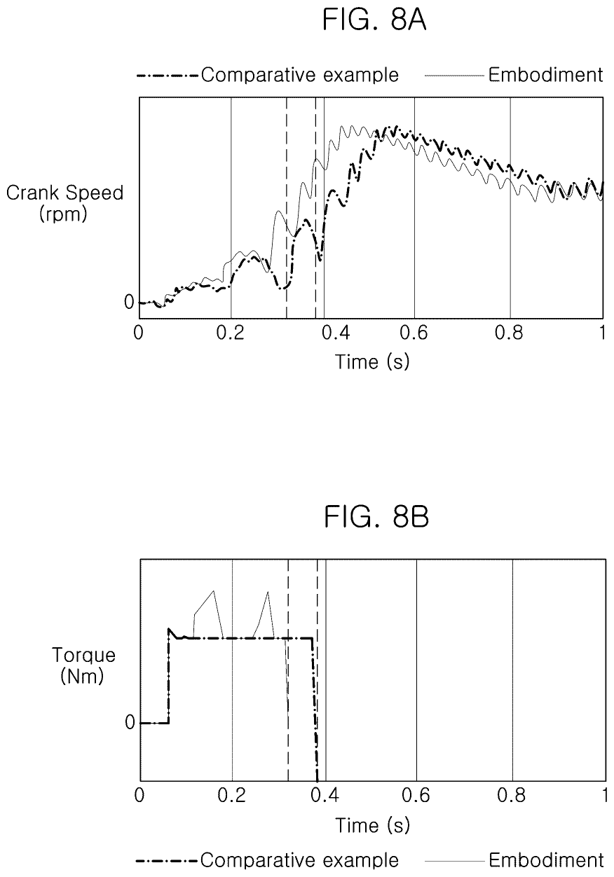

Hereinafter, the effects of the present disclosure are described in FIGS. 7 and 8 through comparison between a comparative example to which the present disclosure is not applied and an experiment of an embodiment of the present disclosure.

FIGS. 7A and 7B illustrate an effect of an embodiment of the present disclosure compared to a comparative example in a case where time intervals from a start of ignition to complete explosion are the same.

Referring to FIGS. 7A and 7B, a torque/rpm graph according to the comparative example is illustrated in FIG. 7A and a torque/rpm graph according to the embodiment is illustrated in FIG. 7B. In each graph, a horizontal axis indicates time and a vertical axis indicates torque and rpm. In addition, the graphs in FIGS. 7A and 7B may share the same horizontal axis (i.e., time axis).

In both the comparative example and the embodiment, as the ignition is ON, motor applied torque increases until reaching motoring average torque in each example, and the motor applied torque is released from complete explosion, but time intervals from the ignition ON to the complete explosion are the same.

However, in the comparative example, only constant motoring average torque is used, whereas in the embodiment, applied torque obtained by adding correction torque to motoring average torque is lower than that in the comparative example.

In the comparison between the applied torque in the comparative example and the applied torque in the embodiment, when the time interval before the complete explosion for the motoring average torque in the embodiment is configured to be identical to that in the comparative example, it may be identified that the motoring average torque required during the ignition in the embodiment is less than the motoring average torque in the comparative example.

Accordingly, compared to the comparative example, the embodiment of the present disclosure can reduce the required torque of the engine 110, which is required during the ignition, and accordingly, can secure the same ignition time even by the first motor 120 having comparatively less rated torque, compared to the comparative example.

In addition, respective rotation counts of the engine 110 according to the applied torque in the comparative example in FIG. 7A and the applied torque in the embodiment in FIG. 7B are compared, it may be identified that rpm of the engine 110 is greatly changed due to variable torque in the comparative example, but the variable torque is offset by correction torque in the embodiment, and thus the embodiment is advantageous in that the vibration can be reduced during the ignition since the change in rpm of the engine 110 is small.

Accordingly, the embodiment of the present disclosure can reduce vibration in the process of ignition of the engine 110, thereby reducing a user's discomfort, compared to the comparative example.

FIGS. 8A and 8B illustrate a comparison between a comparative example and an embodiment of the present disclosure such that the comparative example and the embodiment have the same average applied torque.

Referring to FIGS. 8A and 8B, a graph showing rpm per time of each of the comparative example and the embodiment is illustrated in FIG. 8A, and a graph showing applied torque per time of each of the comparative example and the embodiment is illustrated in FIG. 8B. Here, the graphs in FIGS. 8A and 8B may share the same horizontal axis (i.e., time axis).

Referring to the graph in FIG. 8A, it may be identified that rpm in the embodiment reaches target rpm corresponding to a complete explosion time (e.g., time point) faster than that in the comparative example. In addition, it may be identified that, like the case in FIGS. 7A and 7B, the change in rpm in the embodiment is smaller than that in the comparative example.

Similarly, referring to the graph in FIG. 8B, when the motoring average torque in the comparative example and the motoring average torque in the embodiment are identical to each other, it may be identified that a time taken until complete explosion is shorter in the embodiment, compared to the comparative example.

Accordingly, when the average applied torque in the embodiment and the average applied torque in the comparative example are identical to each other, reaching the complete explosion time (e.g., time point) is faster in the embodiment, compared to the comparative example, whereby startability can be enhanced.

In addition, similar to FIGS. 7A and 7B, the change in rpm is small in the process of ignition, and thus the level of amplitude of vibration is reduced, whereby a user's discomfort can be reduced.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense, but should be considered in an illustrative sense in all aspects. The scope of the present disclosure shall be determined by reasonable interpretation of the appended claims, and all changes and modifications within an equivalent range of the present disclosure fall within the scope of the present disclosure.

What is claimed is:

1. A method for controlling a hybrid electric vehicle, the method comprising:
predicting, during an ignition, a torque change in a shaft to which an engine and a motor are connected together by determining whether to apply a vibrational contribution due to a combustion pressure torque according to whether initial explosion has occurred during ignition of the engine; and
controlling torque of the motor during the ignition based on the predicted torque change.

2. The method of claim 1, wherein the predicting of the torque change during the ignition comprises:
before the initial explosion, predicting the torque change in consideration of vibrational contributions of a motoring pressure torque of the motor and an inertial torque of the engine; and
after the initial explosion, predicting the torque change in consideration of vibrational contributions of the motoring pressure torque, the inertial torque, and the combustion pressure torque.

3. The method of claim 2, wherein the controlling of the torque of the motor comprises, in a case where, before the initial explosion, a motoring average torque causing occurrence of the motoring pressure torque corresponds to pre-configured maximum motoring torque, performing control to add, to the motoring average torque, correction torque obtained by inverting a positive (+) component of the predicted torque change.

4. The method of claim 2, wherein the controlling of the torque of the motor comprises, in a case where, before the initial explosion, motoring average torque causing occurrence of the motoring pressure torque is less than pre-configured maximum motoring torque, performing control to add, to the motoring average torque, correction torque obtained by inverting a negative (−) component of the predicted torque change.

5. The method of claim 2, wherein the controlling of the torque of the motor comprises, in a case after the initial explosion, performing control to add, to the motoring average torque, correction torque obtained by inverting all the predicted torque change.

6. The method of claim 2, wherein the inertial torque, the motoring pressure torque, and the combustion pressure torque are determined based on a crank shaft angle position of the engine, a number of rotations of the shaft, and the motoring average torque.

7. The method of claim 6, wherein the crank shaft angle position of the engine is determined by adding a pre-configured offset to a resolver position of the motor.

8. The method of claim 7, wherein the pre-configured offset is configured to cause vibration to have a minimum level of amplitude during the ignition in response that torque obtained by summating the motoring average torque and an antiphase of the predicted torque change according to a position of the engine is applied to the motor.

9. The method of claim 8, wherein the level of amplitude of vibration during the ignition is determined based on a square of the torque change, and
wherein the inertial torque is determined according to a pre-configured table based on the crank shaft angle position of the engine and the number of rotations of the shaft.

10. The method of claim 6, wherein the motoring pressure torque is determined according to a pre-configured motoring pressure torque table based on the crank shaft angle position of the engine, the number of rotations of the engine, and the motoring average torque, and
wherein the combustion pressure torque is determined according to a pre-configured combustion pressure torque table based on the crank shaft angle position of the engine, the number of rotations of the engine, and the motoring average torque.

11. A hybrid electric vehicle comprising:
a power train including an engine, a motor, and a shaft to which the engine and the motor are connected together, and
a controller configured to:
predict, during the ignition, a torque change in the shaft, by determining whether to apply a vibrational contribution due to combustion pressure torque according to whether initial explosion has occurred during ignition of the engine; and
control torque of the motor during the ignition based on the predicted torque change.

12. The hybrid electric vehicle of claim 11, wherein the controller is configured to:
before the initial explosion, predict the torque change in consideration of vibrational contributions of motoring pressure torque of the motor and inertial torque of the engine; and
after the initial explosion, predict the torque change in consideration of vibrational contributions of the motoring pressure torque, the inertial torque, and the combustion pressure torque.

13. The hybrid electric vehicle of claim 12, wherein the controller is configured to, in a case where, before the initial explosion, motoring average torque causing occurrence of the motoring pressure torque corresponds to pre-configured maximum motoring torque, control the torque of the motor so as to add, to the motoring average torque, correction torque obtained by inverting a positive (+) component of the predicted torque change.

14. The hybrid electric vehicle of claim 12, wherein the controller is configured to, in a case where, before the initial explosion, motoring average torque causing occurrence of the motoring pressure torque is less than pre-configured maximum motoring torque, control the torque of the motor to add, to the motoring average torque, correction torque obtained by inverting a negative (−) component of the predicted torque change.

15. The hybrid electric vehicle of claim 12, wherein the controller is configured to, in a case after the initial explosion, control the torque of the motor to add, to the motoring average torque, correction torque obtained by inverting all the predicted torque change.

16. The hybrid electric vehicle of claim 12, wherein the controller is configured to determine the inertial torque, the motoring pressure torque, and the combustion pressure torque based on a crank shaft angle position of the engine, the number of rotations of the shaft, and the motoring average torque.

17. The hybrid electric vehicle of claim 16, wherein the controller is configured to determine the crank shaft angle position of the engine by adding a pre-configured offset to a resolver position of the motor.

18. The hybrid electric vehicle of claim 17, wherein the pre-configured offset is configured to cause vibration to have a minimum level of amplitude during the ignition in response to torque obtained by summating the motoring average torque and an antiphase of the predicted torque change according to a position of the engine is applied to the motor.

19. The hybrid electric vehicle of claim 18, wherein the controller is configured to:
determine the level of amplitude of vibration during the ignition based on a square of a change in the number of rotations of the motor; and
determine the inertial torque according to a pre-configured table based on the crank shaft angle position of the engine and the number of rotations of the shaft.

20. The hybrid electric vehicle of claim 16, wherein the controller is configured to:
determine the motoring pressure torque according to a pre-configured motoring pressure torque table based on the crank shaft angle position of the engine, the number of rotations of the engine, and the motoring average torque; and
determine the combustion pressure torque according to a pre-configured combustion pressure torque table based on the crank shaft angle position of the engine, the number of rotations of the engine, and the motoring average torque.
